(19) United States
(12) Patent Application Publication
(10) Pub. No.: US 2025/0005471 A1
(43) Pub. Date: Jan. 2, 2025

(54) PICKING GUIDANCE SYSTEM AND PICKING GUIDANCE METHOD

(71) Applicant: FUJI CORPORATION, Chiryu (JP)

(72) Inventor: Yoshiharu TANIZAWA, Toyota-shi (JP)

(73) Assignee: FUJI CORPORATION, Chiryu (JP)

(21) Appl. No.: 18/708,621

(22) PCT Filed: Dec. 17, 2021
(86) PCT No.: PCT/JP2021/046822

§ 371 Date: May 9, 2024

(51) Int. Cl. G06Q 10/0631; G06Q 10/0875

(52) U.S. Cl. CPC G06Q 10/063114; G06Q 10/0875

(57) ABSTRACT

A picking guidance system for guiding a worker in picking of a member includes an information acquisition section configured to acquire information of a member allocated to a production job in a production area and location information related to a location of the member, and a guidance output section configured to generate and output picking guidance for causing the worker to pick up the member allocated to the production job as a picking target from a storage area of the member. When the picking guidance is generated, in a case where the member that is the picking target includes a member whose location information indicates an area different from the storage area, the guidance output section shows information indicating that picking of the member has been completed and includes the member in the picking guidance.

### TECHNICAL FIELD

The present description discloses a picking guidance system and a picking guidance method.

### BACKGROUND ART

Conventionally, there has been known a guidance for picking a member such as a product or a component. For example, Patent Literature 1 discloses a technique for guiding a worker to a container into which a product is to be put by informing a worker of which container on a conveyor the product has already been put by lighting a lamp or the like in a work of putting the product picked up by the worker into the container on the conveyor.

### PATENT LITERATURE

Patent Literature 1: JP-A-2018-177423

### SUMMARY OF THE INVENTION

### Technical Problem

Here, a member necessary for a production job in a production area such as a factory may be shown in picking guidance and picked up by a worker from a storage area such as a warehouse. In this case, picking of a necessary member is usually guided for each production job; however, picking of a member may become unnecessary due to a reason that picking has been performed in a preceding production job. In this case, when the member is included in the picking guidance, the picking of the member not present in the storage area is guided, which is not preferable. Meanwhile, when the member is excluded from the picking guidance, the worker cannot recognize that the member is necessary for the production job.

A main object of the present disclosure is to appropriately guide a member requiring picking while enabling recognition of each member allocated to a production job.

### Solution to Problem

The present disclosure employs the following means in order to achieve the main object described above.

According to an aspect of the present disclosure, there is provided a picking guidance system for guiding a worker in picking of a member, the picking guidance system including:
an information acquisition section configured to acquire information of a member allocated to a production job in a production area and location information related to a location of the member; and
a guidance output section configured to generate and output picking guidance for causing the worker to pick up the member allocated to the production job as a picking target from a storage area of the member, in which
when the picking guidance is generated, in a case where the member that is the picking target includes a member whose location information indicates an area different from the storage area, the guidance output section shows information indicating that picking of the member has been completed and includes the member in the picking guidance.

In the picking guidance system of the present disclosure, when the picking guidance is generated, in a case where the member that is the picking target includes a member whose location information indicates an area different from the storage area, information indicating that picking of the member has been completed is shown, and the member is included in the picking guidance. Therefore, even when the member is included in the picking guidance, the worker can recognize that the member has already been picked up and is not required to be picked up. In addition, since even a member that does not require picking is included in the picking guidance, the worker can recognize the member allocated to the production job by looking at the picking guidance. Accordingly, it is possible to appropriately guide a member requiring picking while making it possible to recognize each member allocated to a production job.

### BRIEF DESCRIPTION OF DRAWINGS

FIG. 1 is a configuration diagram illustrating an outline of a configuration of production system 10.

FIG. 2 is a diagram illustrating an example of component list PL.

FIG. 3 is a diagram illustrating an example of reel information 32a.

FIG. 4 is a diagram illustrating an example of a production work process.

FIG. 5 is a flowchart illustrating an example of an allocation process.

FIG. 6 is a diagram illustrating an example of presence or absence of picking guidance according to the present embodiment.

FIG. 7 is a diagram illustrating presence or absence of picking guidance in a comparative example.

FIG. 8 is a flowchart illustrating an allocation process according to a modification.

FIG. 9 is a flowchart illustrating an example of an alternative reel allocation process.

### DESCRIPTION OF EMBODIMENTS

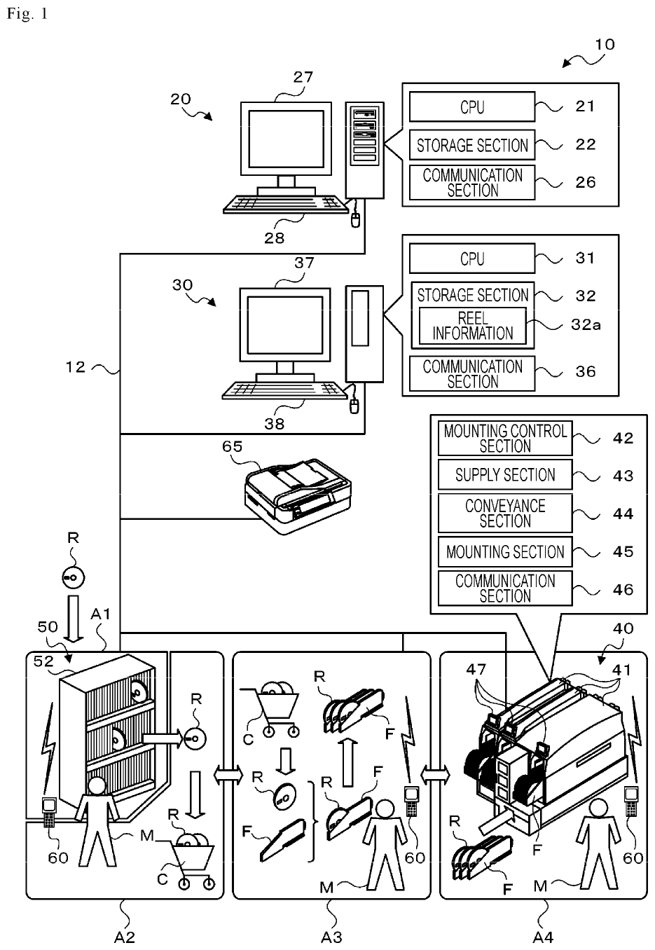

Next, embodiments of the present disclosure will be described with reference to the accompanying drawings. FIG. 1 is a configuration diagram illustrating an outline of a configuration of production system 10. Production system 10 includes general management device 20, production management device 30, mounting line 40 for performing a mounting process of component P, and storage 50 for storing an accommodation member such as reel R around which a tape accommodating component P is wound. Mounting line 40 includes multiple mounting devices 41 that collect components P from reels R, trays, or the like and mount components P on substrate S. In addition to mounting device 41, mounting line 40 includes a printing device that prints solder on substrate S, a reflow device that performs a reflow process on substrate S on which component P is mounted, and the like. Storage shelf 52 that stores multiple members such as reels R is disposed in storage 50.

In production system 10, general management device 20 and production management device 30 are communicably connected to each mounting device 41 of mounting line 40 via network 12 such as a wired LAN or a wireless LAN. General management device 20 and production management device 30 are connected to mobile terminal 60 held by worker M, known printer 65 that prints various forms, and the like via network 12. Mobile terminal 60 is capable of displaying various kinds of information on a display screen, inputting various kinds of information using an input button, reading a code such as a bar code or a two-dimensional code attached to reel R or the like, and acquiring identification information.

General management device 20 is configured as a microprocessor centered on CPU 21, and includes storage section 22 that stores various data, communication section 26 that performs communication via network 12, display section 27 that displays various information, and input section 28 such as a mouse and a keyboard that input various instructions. General management device 20 exchanges information with production management device 30, mobile terminal 60, and the like by communication of communication section 26. Storage section 22 stores information related to work order WO which is a production order for production system 10, or the like. The information related to work order WO includes, for example, information related to the type and the number of substrates S to be produced, a delivery date, the type of components P mounted on substrates S, and a required number which is the number of components required.

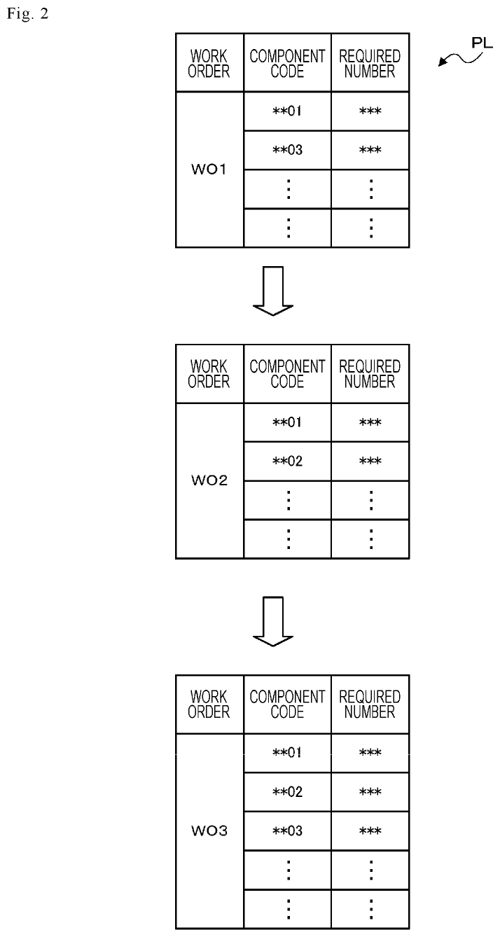

In addition, general management device 20 can create component list PL in which the types and the required number of components P are listed for each work order WO. FIG. 2 is a diagram illustrating an example of component list PL. Component list PL includes a component code indicating the type of required component P and the required number for each work order WO. Work orders WO1, WO2, and WO3 are produced in this order. Component list PL is printed as a form by printer 65 or displayed on the display screen of mobile terminal 60. Therefore, worker M can check the type and the required number of components P necessary for work order WO from component list PL. Note that, in the present embodiment, picking guidance for picking up reels R accommodating required components P from storage 50 is output separately from component list PL, and details thereof will be described later.

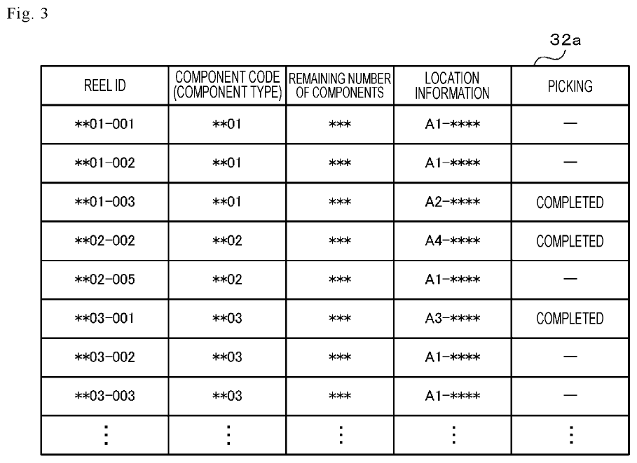

Production management device 30 is configured as a microprocessor centered on CPU 31, and includes storage section 32 that stores various data, communication section 36 that performs communication via network 12, display section 37 that displays various information, and input section 38 such as a mouse and a keyboard that input various instructions. Production management device 30 exchanges information with general management device 20, each mounting device 41 of mounting line 40, mobile terminal 60, and the like by communication of communication section 36. Storage section 32 stores reel information related to reels R in production system 10 and the like. FIG. 3 is a diagram illustrating an example of reel information 32a. Reel information 32a includes reel ID which is unique identification information of each reel R, a component code of component P in reel R and the remaining number of components P, location information of reel R, information on whether picking has been completed from storage 50, and the like. Production management device 30 appropriately updates reel information 32a based on information from mobile terminal 60 and information from each mounting device 41 of mounting line 40.

Each mounting device 41 of mounting line 40 includes mounting control section 42, supply section 43, conveyance section 44, mounting section 45, communication section 46, and operation panel 47. Mounting control section 42 is configured as a microprocessor centered on CPU, and includes storage section or the like configured to store various data. Mounting control section 42 exchanges information with and controls supply section 43, conveyance section 44, mounting section 45, communication section 46, and operation panel 47. Supply section 43 is a unit that supplies component P to mounting section 45. Supply section 43 has multiple slots in which feeders F to which reels R are assembled are mounted, and also has a tray unit that accommodates a tray on which components P are placed. Conveyance section 44 is a unit that conveys and fixes substrate S. Mounting section 45 is a unit that collects component P from supply section 43, and mounts component P on substrate S fixed to conveyance section 44. Mounting section 45 includes a head to which a suction nozzle for collecting (picking up) component P is attached, and a moving section that moves the head in X and Y directions. Component P may be collected by a mechanical chuck or the like. Communication section 46 exchanges information with production management device 30 and the like via network 12. Operation panel 47 includes a display section serving as a display that displays a screen, and an operation section that accepts an input from worker M.

Here, production system 10 of the present embodiment includes shelf area A1, picking area A2, external setup area A3, and line area A4. Shelf area A1 is a storage area in which storage shelf 52 of storage 50 is arranged. Picking area A2 is an area where reels R picked up from storage shelf 52 of shelf area A1 are collected. External setup area A3 is a preparation area in which a production preparation such as an external setup in which worker M assembles reel R to feeder F is performed. Line area A4 is a production area in which mounting lines 40 are arranged and production is performed. The location of reel R before being received in storage 50 and stored in shelf area A1 may be distinguished from shelf area A1 and set as a warehouse area. Reel information 32a in FIG. 3 indicates that reel R whose location information is, for example, “A1-****” is in shelf area A1, and the same applies to areas A2 to A4 other than shelf area A1.

When picking up reel R in storage shelf 52, that is, shelf area A1, worker M reads the code of reel R with mobile terminal 60. Accordingly, the reel ID of reel R and information indicating that reel R has been picked up are transmitted to production management device 30. Further, worker M reads the code of reel R with mobile terminal 60 when moving picked reel R to picking area A2, for example, by putting picked reel R into cart C of picking area A2. Accordingly, the reel ID of reel R and the location information indicating that reel R is in picking area A2 are transmitted to production management device 30. When picking up reel R from shelf area A1 and reading the code of reel R, the location information of reel R may be picking area A2.

Further, worker M reads the code of reel R with mobile terminal 60 when transporting reel R from picking area A2 to external setup area A3. As a result, the reel ID of reel R and the location information indicating that reel R is in external setup area A3 are transmitted to production management device 30. When multiple reels R that have entered cart C are collectively moved between the areas, the location information of reels R in cart C may be collectively transmitted to production management device 30 by reading the code of cart C with mobile terminal 60. In external setup area A3, worker M assembles reel R to feeder F and then transports feeder F to which reel R is assembled to line area A4. When assembling reel R to feeder F, worker M reads the code of reel R with mobile terminal 60. Accordingly, information on reels R assembled to feeders F is transmitted to production management device 30. Although not illustrated, storage section 32 of production management device 30 stores assembly information of feeders F and reels R.

In line area A4, worker M attaches feeder F to the slot of supply section 43 of mounting device 41. The work of attaching feeder F to which reel R is assembled to mounting device 41 is also referred to as internal setup. Mounting control section 42 acquires information of feeder F through communication with the control section of feeder F attached to the slot, and requests information of reel R from production management device 30 based on the information. Production management device 30 acquires the component code and the remaining number from reel information 32a based on the reel ID specified by collating the assembly information, and transmits the component code and the remaining number to mounting device 41. Mounting control section 42 checks whether reel R is as allocated based on the received reel ID, component code, and remaining number.

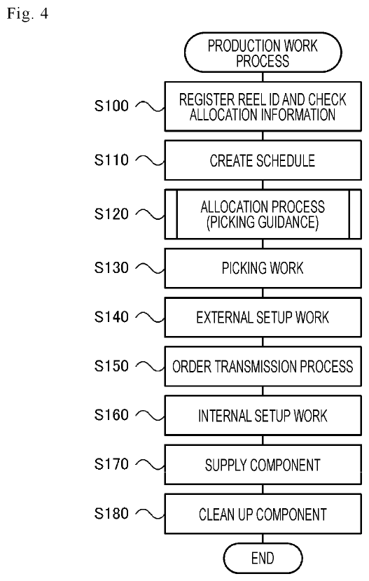

Next, various works and various processes performed in production system 10 configured as described above will be described. First, an outline of a production work process in production system 10 will be described. FIG. 4 is a diagram illustrating an example of a production work process. In this production work process, general management device 20 first registers the reel ID of reel R received in storage 50 or the like (S100). In S100, the unique reel ID of reel R is registered by adding the identification code (management number) of reel R to the component code of component P accommodated in reel R. Upon completion of the registration of the reel ID, reel R is set to be allocated. In addition, information related to the allocation such as the allocation status for each reel ID is also checked.

Next, production management device 30 creates a schedule of mounting line 40 based on the information of work order WO stored in general management device 20 (S110). In S110, based on the production efficiency of mounting line 40, the number of substrates S produced in each work order WO, and the like, a schedule in which the timing of starting production of each work order WO, the timing of picking or setup for that, and the like are determined is created. In addition, in the schedule, the type and the required number of components P to be mounted in each mounting device 41 are also determined.

Next, production management device 30 executes the allocation process of reels R according to the type and the required number of components P (S120). Although details will be described later, in the allocation process, reels R are allocated in units of reel IDs, and it is determined on which slot of each mounting devices 41 feeder F to which reel R is assembled is mounted. Further, a picking slip indicating picking guidance of reel R and a setup change slip indicating guidance of setup change are issued. When the picking slip is issued, worker M performs a picking work in shelf area A1 (S130), and collects picked reels R in picking area A2.

When reel R is transported to external setup area A3, worker M in external setup area A3 performs the external setup work (S140), and the assembly information of reel R and feeder F is transmitted to production management device 30. Meanwhile, production management device 30 executes a transmission process of transmitting work order WO to mounting line 40 (S150). Production management device 30 transmits work order WO as needed based on the production schedule and the production status of mounting line 40.

When feeder F (reel R) is transported to line area A4, worker M in line area A4 performs the internal setup work (S160). In S160, worker M mounts feeder F on the slot of each mounting device 41 or mounts a tray on which tray components (not illustrated) are placed on supply section 43 while referring to the setup change slip or the screen display of operation panel 47. In mounting line 40, when it is checked that necessary feeder F (reel R) is mounted on each mounting device 41, the mounting process based on work order WO is started.

When the mounting process is started, worker M in line area A4 supplies components as needed (S170). For example, worker M performs the supply when a shortage occurs in component P or the tray component of feeder F while checking a production state or the like on operation panel 47 of each mounting device 41 or mobile terminal 60. In addition, worker M in line area A4 performs cleanup of the components, for example, collecting feeders F (reels R) that become unnecessary due to the end of production or the like from mounting device 41 (S180). Feeder F (reel R) collected in S180 is temporarily placed in line area A4 or transported to external setup area A3 according to the use schedule. Worker M in external setup area A3 removes reels R from feeders F and transports the removed reels R to picking area A2. Reels R transported to picking area A2 are transported to shelf area A1 as needed and stored in storage shelf 52.

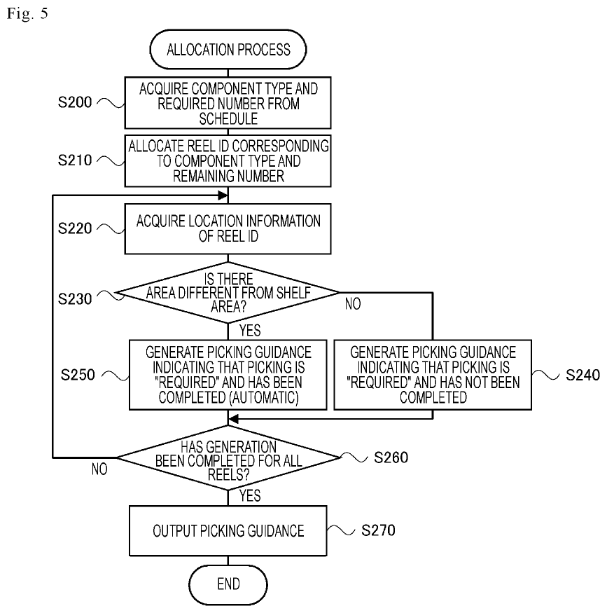

Next, details of the allocation process of S120 will be described. FIG. 5 is a flowchart illustrating an example of the allocation process. In the allocation process, CPU 31 of production management device 30 first acquires the component type (component code) and the required number of components P for each work order WO from the schedule created in S110 (S200). Next, CPU 31 allocates the reel ID of reel R corresponding to the component type and the remaining number with reference to reel information 32a (S210). In S210, a process of searching reel information 32a for reels R having the same component type and the remaining number equal to or more than a required number and allocating the reel ID of reel R is performed. In consideration of an error in the remaining number of components P, reels R having the remaining number of components equal to or more than a value obtained by adding a margin to the required number may be allocated.

Next, CPU 31 acquires the location information of the allocated reel R from reel information 32a (S220), and determines whether the location information is in another area different from shelf area A1 (S230). When it is determined that reel R is in shelf area A1, CPU 31 generates picking guidance indicating that the picking is “required” and the picking is “not completed” in order to perform the picking (S240). Conversely, when it is determined that reel R is in another area, CPU 31 generates picking guidance indicating that picking is “required” and picking is “completed (automatic)” in order to cause worker M to recognize that picking is not necessary in shelf area A1 but reel R is necessary for production (S250). That is, information indicating that the picking has already been completed is shown while the picking is “required”, and guidance that does not actually require picking is generated.

Next, CPU 31 determines whether the picking guidance of all reels R allocated to work order WO has been generated (S260), and when it is determined that the picking guidance is not generated, CPU 31 returns to S220 and performs the process. Meanwhile, when CPU 31 determines that the picking guidance of all reels R has been generated, CPU 31 outputs the generated picking guidance (S270) and ends the allocation process. In S270, the picking slip (form) indicating the picking guidance is printed by printer 65, displayed on the display screen of mobile terminal 60, or displayed on the display section 37. The picking guidance includes the reel ID of each reel R for which the picking is “required”, the location information, and the picking state. The picking state indicates either “not completed” or “completed (automatic)” at the beginning of the output of the picking guidance. When the “not completed” reel R is picked up, the state is changed to “completed”. That is, the picking state indicates any one of “not completed”, “completed”, and “completed (automatic)”.

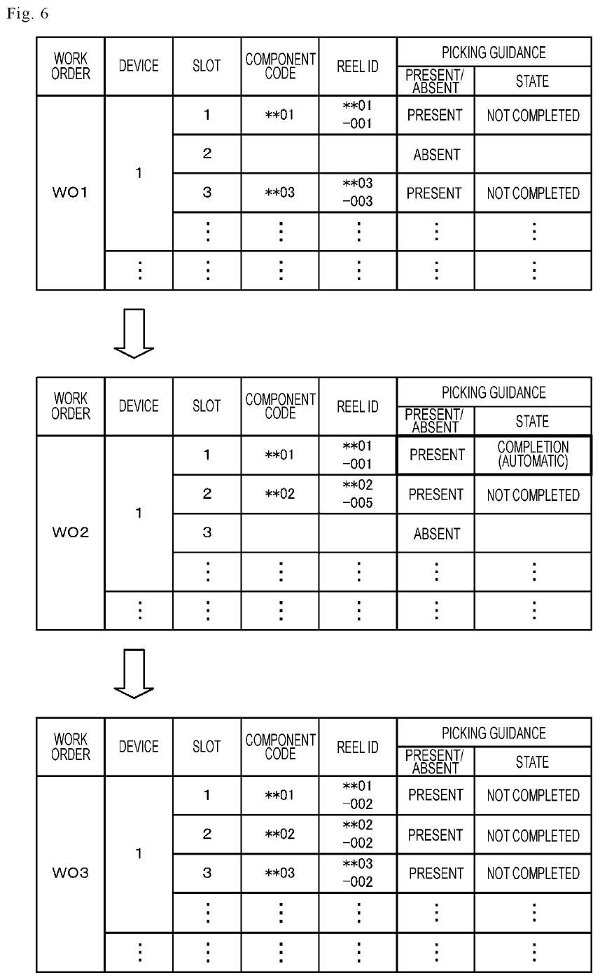

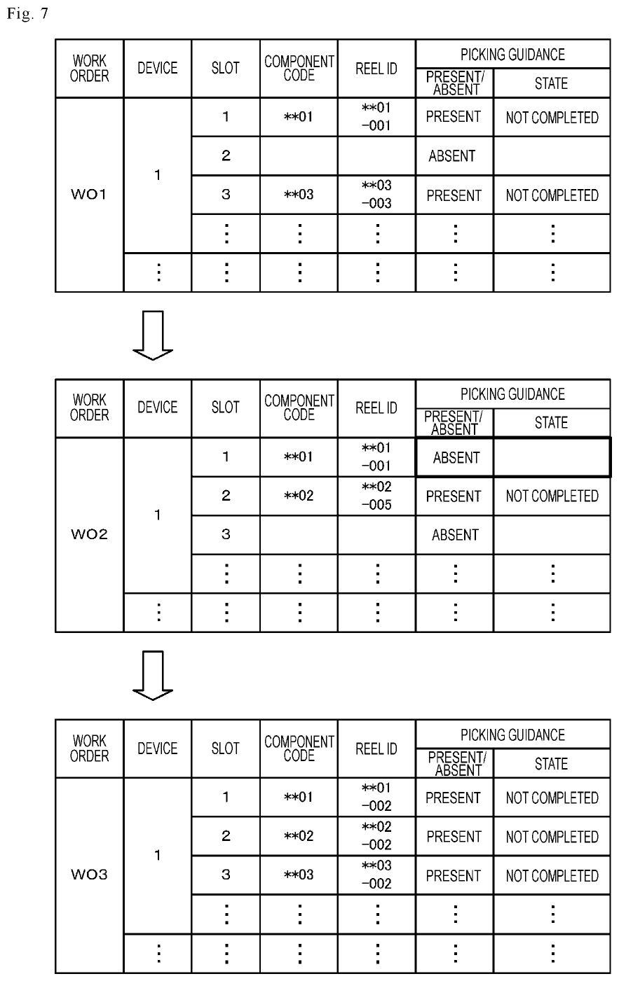

Here, FIG. 6 is a diagram illustrating an example of presence or absence of the picking guidance according to the present embodiment, and FIG. 7 is a diagram illustrating presence or absence of the picking guidance according to a comparative example. In FIGS. 6 and 7, the device number of mounting device 41, the slot number of supply section 43, the component code, and the reel ID are associated with each other for each of the work orders WO1 to WO3, and the presence or absence of the picking guidance and the picking state are illustrated. For example, FIG. 6 illustrates a state in which reel R having a component code of “**01” and a reel ID of “**01-001” is set in slot 1 in mounting device 41 of the device number 1 of work order WO1, and the picking is “required” and “not completed”. Further, since no reel R is set in slot 2, the picking is “not required”. The same applies to other slots of work order WO1 and other work orders WO2 and WO3.

FIGS. 6 and 7 illustrate a case where, when the work order is switched from work order WO1 to work order WO2, reels R (feeders F) having the reel ID “**01-001” of slot 1 are used as they are, and picking is unnecessary. In the present embodiment, when the picking guidance of work order WO2 is created, it is determined that reel R having the reel ID of “**01-001” is in another area, and thus, as illustrated in FIG. 6, the guidance indicating that the picking is “required” and “completed (automatic)” is created. Therefore, worker M who views the picking guidance can recognize that reel R having the reel ID of “**01-001” (component P having the component code of “**01”) is used in work order WO2 although picking is actually unnecessary.

Meanwhile, in the comparative example, only reels R that actually require picking are included in the picking guidance. Therefore, as illustrated in FIG. 7, in the picking guidance of work order WO2, the picking of reel R of “**01-001” is “not required” and is not included in the picking guidance. Accordingly, worker M cannot recognize that reel R with the reel ID “**01-001” (component P with the component code “**01”) is used in work order WO2 even when worker M looks at the picking guidance, and cannot know component P necessary for production.

Here, there is a case where worker M performs so-called double check in which checking of the picked reel R (component P) is performed by both picking guidance and component list PL (see FIG. 2). In this case, in the comparative example, although component P having the component code “**01” is included in component list PL, component P is not included in the picking guidance, and inconsistency occurs between the picking guidance and component list PL. Therefore, worker M cannot check the necessary component P (reel R), and the work is hindered. Meanwhile, in the present embodiment, even when picking is actually unnecessary, “completion (automatic)” is set and included in picking guidance, and thus it is possible to prevent occurrence of inconsistency between picking guidance and component list PL, and to cause worker M to reliably check necessary components P (reels R).

Here, a correspondence relationship between the elements of the present embodiment and the elements of the present disclosure will be clarified. CPU 31 of production management device 30 that executes S200 and S220 of the allocation process of the present embodiment corresponds to an information acquisition section of the present disclosure, and CPU 31 that executes S230 to S250 and S270 of the allocation process, mobile terminal 60, and printer 65 correspond to a guidance output section of the present disclosure. In addition, in the present embodiment, an example of the picking guidance method of the present disclosure is also clarified by describing the processing of CPU 31.

In production system 10 described above, when there is reel R whose location information is in an area different from shelf area A1, information indicating that the picking has been completed is shown and the reel R is included in the picking guidance. Therefore, it is possible for worker M to be able to recognize each reel R that has been allocated, and to appropriately guide reels R that actually require picking.

In addition, even in a case where worker M uses both component list PL and the picking guidance, it is possible to prevent inconsistency between component list PL and the picking guidance and allow necessary components P (reels R) to be appropriately checked.

As a matter of course, the present disclosure is not limited to the above-described embodiment in any way, and the present disclosure can be embodied in various aspects without departing from the technical scope of the present disclosure.

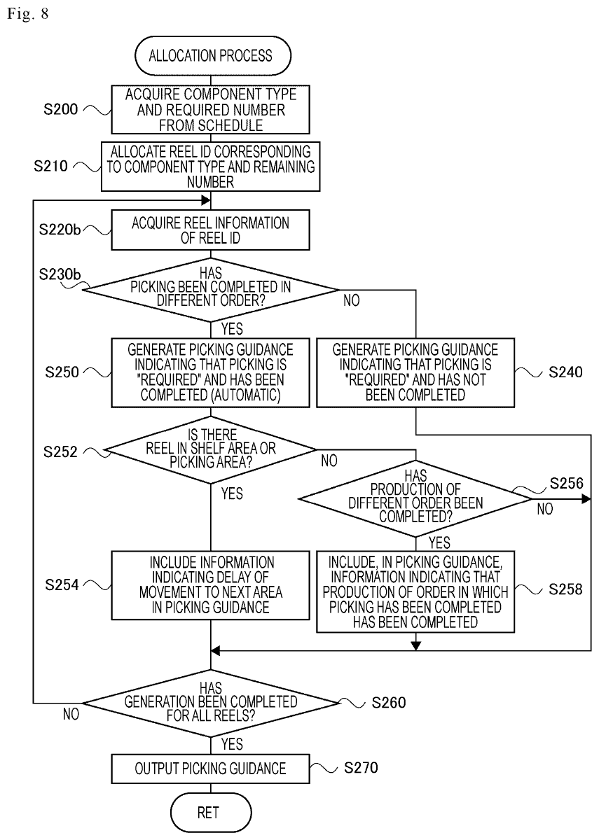

In the embodiment described above, when reel R is in an area different from shelf area A1, information indicating that the picking has been completed automatically is shown; however, the configuration is not limited to this, and the following modification may be made. FIG. 8 is a flowchart illustrating an allocation process according to a modification. In the modification, the same process as in the embodiment is given the same step number, and description thereof will be omitted. In FIG. 8, CPU 31 acquires the reel information of the reel ID allocated in S210 (S220b), and determines whether picking has been completed in work order WO different from work order WO allocated this time (S230b). When it is determined that the picking has not been completed in different work order WO, CPU 31 executes the process of S240 and proceeds to S260.

Meanwhile, when CPU 31 determines that the picking has been completed in different work order WO, CPU 31 generates the process of S250, that is, the picking guidance indicating that the picking is “required” and completed (automatic). Next, CPU 31 determines whether reel R is in either shelf area A1 or picking area A2 (S252). The determination in S252 is a process of determining whether reel R is in shelf area A1 or in picking area A2, that is, picked reel R is not transported to external setup area A3. Further, since reels R are not transported to external setup area A3, it can be said that it is a process of determining whether reels R are left in the storage area (here, shelf area A1 and picking area A2) in which reels R before the work are placed.

When it is determined in S252 that reel R is in either shelf area A1 or picking area A2, CPU 31 includes, in the picking guidance, information indicating delay of movement (transport) to the next area (S254), and proceeds to S260. Accordingly, in the picking guidance, it is shown that reel R has been picked but has not been transported to external setup area A3, and it is possible to alert worker M.

Meanwhile, when it is determined in S252 that reel R is not in shelf area A1 or picking area A2, CPU 31 determines whether production of different work order WO in which reel R is picked up is completed (S256). When determining that the production of different work order WO is not completed, CPU 31 proceeds to S260. When CPU 31 determines that the production of different work order WO has been completed, CPU 31 includes, in the picking guidance, information indicating that the production of work order WO in which picking has been completed has been completed (S258), and proceeds to S260.

Accordingly, in the picking guidance, it is indicated that there is a reel R picked up in different work order WO and the production of different work order WO is already completed. Here, for example, in a case where reel R that becomes unnecessary for production is temporarily placed in external setup area A3 in a state of being detached from feeder F, reel R may be picked up from the temporary place. Therefore, by causing worker M to recognize that picking has been completed in different work order WO and production of work order WO has been completed, it is possible to alert the possibility that reel R is in a temporary place.

In this modification, worker M may be caused to input picking completion in order to further alert. In this case, in S250, while generating the picking guidance indicating that the picking is “required” but has not been completed, the alert may be included in the picking guidance in S254 or S258 and picking completion may be input. Also in this case, in order to indicate a difference from the normal picking guidance in S248, the picking guidance in S250 may be shown in a display color different from that of the picking guidance in S248, or may be indicated in a different guidance mode, for example, by adding a specific message such as “attention is required” for calling attention.

In the modification, it is determined in S252 whether reel R is in shelf area A1 or picking area A2; however, the configuration is not limited to this. For example, in S252, it may be determined whether reel R is in shelf area A1. In this case, the process of S254 is performed on reels R that have been picked up but have not been transported to picking area A2. In addition, in the modification, both the processes of S252 and S254 and the processes of S256 and S258 are performed, but a first one of the processes of S252 and S254 and the processes of S256 and S258 may be performed and a second one thereof needs not be performed.

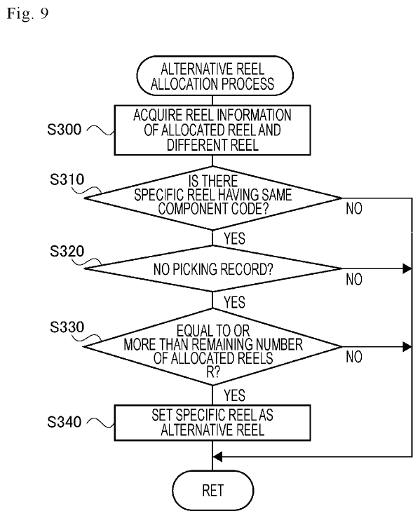

In the embodiment, allocated reel R is guided for the picking as it is; however, the configuration is not limited to this, as long as a predetermined condition is met, the picking guidance may be provided using an alternative reel to replace originally allocated reel R. FIG. 9 is a flowchart illustrating an example of the alternative reel allocation process. This process may be executed, for example, after S210 of the allocation process. Alternatively, the processing may be executed when there is an instruction from worker M.

In FIG. 9, CPU 31 acquires reel information 32a of allocated reel R and different reel R (S300). Next, CPU 31 determines whether there is specific reel R having the same component code (component type) as that of any of different reels R that have been allocated (S310), and when it is determined that there is no specific reel R, CPU 31 ends the alternative reel allocation process.

Meanwhile, when it is determined that there is specific reel R, CPU 31 determines whether specific reel R is a reel R that does not have a picking record (S320), and determines whether the remaining number of components P of the specific reel R is equal to or more than the remaining number of allocated reel R (S330). In S330, it may be determined whether the number of components P is equal to or more than the required number when reel R is allocated. The determination in S320 is a process of determining whether specific reel R is new reel R that has not been picked up in the past. This is because there is almost no possibility that an error occurs in the remaining number of components P in the case of new reel R, and the reliability of the determination in S330 is improved. The present disclosure is not limited to the processing of S320, and the processing of S320 may be omitted.

When negative determination is made in S320 or S330, CPU 31 ends the alternative reel allocation process. When it is determined that the remaining number of specific reels R is equal to or more than the remaining number of allocated reels R and there is no picking record of specific reels R, CPU 31 sets specific reels R as the alternative reels (S340) and ends the alternative reel allocation process. After the alternative reels are set, the processing of S220 (S220b) and subsequent steps are performed on the alternative reels, and picking guidance is performed. An alternative reel may be set for multiple reels R among reels R allocated to one work order WO.

As described above, since the alternative reel can be allocated, in a case where originally allocated reel R cannot be used or cannot be picked for some reason, production can be performed using different reel R. Examples of the reasons include a reason that reel R is suddenly used in different work order WO, a reason that component P is consumed more than expected and the remaining number thereof becomes short, a reason that the production in work order WO in which reel R is used earlier is delayed and reel R cannot be prepared in time, and the like. Alternatively, in a case where worker M accidentally carries reel R that may be an alternative reel or is placed near worker M, the alternative reel can be allocated, and thus it is possible to efficiently perform the work while saving the time and effort of picking. Note that worker M may input the reel ID of reel R that may be the alternative reel using mobile terminal 60 or the like, and perform the process of FIG. 9 in order to determine whether reel R is the alternative reel.

In the embodiment, reels R are allocated in reel ID units; however, the configuration is not limited to this, and reels R may be allocated by component codes or the like.

In the embodiment, component list PL can be output, and the picking guidance and component list PL can be checked; however, the configuration is not limited to this, and it is not necessary to use component list PL. In addition, production system 10 includes two management devices (general management device 20 and production management device 30) to share each function and each process, but the sharing of each function and each process is an example and is not limited to the content of the embodiment. Production system 10 is not limited to a system including two management devices, and may include three or more management devices or only one management device.

In the embodiment, reel R is exemplified as a member allocated to a production job; however, the configuration is not limited to this, and any member used for production and picked up from a storage area may be used. For example, when the head of mounting section 45 is configured to be detachable, the member may be the head or a suction nozzle attached to the head. In addition, as an example of production, the mounting process of mounting component P on substrate S by mounting device 41 is exemplified; however, the configuration is not limited to this, and other processes such as a process of assembling a component by a multi-axis robot such as a vertical articulated robot may be used.

Here, the picking guidance system of the present disclosure may be configured as follows. For example, according to the present disclosure, there is provided a picking guidance system for guiding a worker in picking of a member, the picking guidance system including: an information acquisition section configured to acquire information of a member allocated to a production job in a production area and location information related to a location of the member; and a guidance output section configured to generate and output picking guidance for causing the worker to pick up the member allocated to the production job as a picking target from a storage area of the member, in which the information acquisition section acquires information indicating that the member is picked up when the member is picked up from the storage area, and when the member that is the picking target includes a member that has been picked up in a production job different from the production job for generating the picking guidance, the guidance output section shows information indicating that picking of the member has been completed and includes the member in the picking guidance. Accordingly, it is possible to appropriately guide a member that needs to be picked up while making it possible to recognize each member allocated to the production job.

In the picking guidance system of the present disclosure, when the member that is the picking target includes a member that has been picked up in the different production job and whose location information indicates the storage area, the guidance output section may include information indicating such a fact in the picking guidance. In this way, even when picking has been completed in the different production job, the worker can pay attention to a member that has not moved from the storage area to another area.

In the picking guidance system of the present disclosure, when the member that is the picking target has been picked in the different production job and production of the different production job has been completed, the guidance output section may include information indicating such a fact in the picking guidance. In this way, it is possible to pay attention of the worker to the member that has been picked up in the different production job and has been used in the different production job.

In the picking guidance system of the present disclosure, a list indicating a table of members allocated to the production job may be used in a production system configured to enable the worker to check while collating the list with the picking guidance. Since the picking guidance includes a member that does not require picking, the picking guidance can be matched with a list indicating the table of members. Therefore, the worker can appropriately check whether the picking of the members necessary for the production job is completed by using the picking guidance and the list indicating the table of the members.

In the picking guidance system of the present disclosure, the member allocated to the production job may be allocated by using an identification code indicating unique identification information assigned to each member, and the guidance output section may generate the picking guidance by showing the identification code of the member that is the picking target. In this way, it is possible to more appropriately perform the picking guidance when a member is allocated based on the unique identification information.

In the picking guidance system of the present disclosure, when there is an alternative member that is a member of the same type and satisfies a condition used in the production job, the guidance output section may be able to generate the picking guidance by showing the alternative member. In this way, the degree of freedom of selection of the member that is the picking target can be increased, and the picking guidance can be performed more appropriately.

According to the present disclosure, there is provided a picking guidance method for guiding a worker in picking of a member, the method including: (a) a step of acquiring information of a member allocated to a production job in a production area and location information related to a location of the member; and (b) a step of generating and outputting picking guidance for causing the worker to pick up the member allocated to the production job as a picking target from a storage area of the member, in which in the step (b), when the picking guidance is generated, in a case where the member that is the picking target includes a member whose location information indicates an area different from the storage area, information indicating that picking of the member has been completed is shown, and the member is included in the picking guidance.

Similarly to the above-described picking guidance system, the picking guidance method according to the present disclosure can appropriately guide a member that needs to be picked up while making it possible to recognize each member allocated to the production job. In this picking guidance method, various aspects of the above-described picking guidance system may be adopted, or a step of achieving each function of the above-described picking guidance system may be added.

### INDUSTRIAL APPLICABILITY

The present disclosure can be used in a technical field of performing production using a member, such as a mounting process of a component.

### REFERENCE SIGNS LIST

10: production system, 12: network, 20: general management device, 21, 31: CPU, 22, 32: storage section, 26, 36: communication section, 27, 37: display section, 28, 38: input section, 30: production management device, 32a: reel information, 40: mounting line, 41: mounting device, 42: mounting control section, 43: supply section, 44: conveyance section, 45: mounting section, 46: communication section, 47: operation panel, 50: storage, 52: storage shelf, 60: mobile terminal, 65: printer, A1: shelf area, A2: picking area, A3: external setup area, A4: line area, F: feeder, M: worker, P: component, PL: component list, R: reel, S: substrate

1. A picking guidance system for guiding a worker in picking of a member, the picking guidance system comprising:
an information acquisition section configured to acquire information of a member allocated to a production job in a production area and location information related to a location of the member; and
a guidance output section configured to generate and output picking guidance for causing the worker to pick up the member allocated to the production job as a picking target from a storage area of the member,
wherein when the picking guidance is generated, in a case where the member that is the picking target includes a member whose location information indicates an area different from the storage area, the guidance output section shows information indicating that picking of the member has been completed and includes the member in the picking guidance.

2. A picking guidance system for guiding a worker in picking of a member, the picking guidance system comprising:
an information acquisition section configured to acquire information of a member allocated to a production job in a production area and location information related to a location of the member; and
a guidance output section configured to generate and output picking guidance for causing the worker to pick up the member allocated to the production job as a picking target from a storage area of the member,
wherein the information acquisition section acquires information indicating that the member is picked up when the member is picked up from the storage area, and
in a case where the member that is the picking target includes a member picked up in a production job different from the production job for generating the picking guidance, the guidance output section shows information indicating that picking of the member has been completed and includes the member in the picking guidance.

3. The picking guidance system according to claim 2, wherein when the member that is the picking target includes a member that has been picked up in the different production job and whose location information indicates the storage area, the guidance output section includes information indicating such a fact in the picking guidance.

4. The picking guidance system according to claim 2, wherein when the member that is the picking target has been picked in the different production job and production of the different production job has been completed, the guidance output section includes information indicating such a fact in the picking guidance.

5. The picking guidance system according to claim 1, wherein a list indicating a table of members allocated to the production job is used in a production system configured to enable the worker to check while collating the list with the picking guidance.

6. The picking guidance system according to claim 1, wherein the member allocated to the production job is allocated by using an identification code indicating unique identification information assigned to each member, and
the guidance output section generates the picking guidance by showing the identification code of the member that is the picking target.

7. The picking guidance system according to claim 1, wherein when there is an alternative member that is a member of the same type and satisfies a condition used in the production job, the guidance output section able to generate the picking guidance by showing the alternative member.

8. A picking guidance method for guiding a worker in picking of a member, the method comprising:
(a) a step of acquiring information of a member allocated to a production job in a production area and location information related to a location of the member; and
(b) a step of generating and outputting picking guidance for causing the worker to pick up the member allocated to the production job as a picking target from a storage area of the member,
wherein in the step (b), when the picking guidance is generated, in a case where the member that is the picking target includes a member whose location information indicates an area different from the storage area, information indicating that picking of the member has been completed is shown, and the member is included the information in the picking guidance.
